(19) United States
(12) Patent Application Publication
(10) Pub. No.: US 2026/0059376 A1
(43) Pub. Date: Feb. 26, 2026

(54) SYSTEM AND METHOD FOR PER SERVICE FLOW QUALITY-OF-SERVICE MONITORING

(71) Applicant: Verizon Patent and Licensing Inc., Basking Ridge, NJ (US)

(72) Inventors: Lixia Yan, Basking Ridge, NJ (US); Ambreen Habib, Golden, CO (US); Violeta Cakulev, Millburn, NJ (US); Sudhakar Reddy Patil, Flower Mound, TX (US)

(21) Appl. No.: 18/813,200

(22) Filed: Aug. 23, 2024

(51) Int. Cl. H04W 28/02; H04L 12/14

(52) U.S. Cl. CPC H04W 28/0268; H04L 12/1407

(57) ABSTRACT

A system may include a first core network component. The first network component may be configured to: receive, from a second core network component, a reply which indicates that a Quality-of-Service (QoS) monitoring is to be performed for a flow associated with a User Equipment device (UE); provide information to a third core network component to establish a Protocol Data Unit (PDU) session with the UE and monitor the PDU session over a transport network; and send a message to a fourth core network component that notifies an access station to allocate resources for the PDU session.

### BACKGROUND INFORMATION

To satisfy the needs and demands of users of mobile communication devices, mobile network operators continue to improve and expand their networks. One aspect of such improvements includes obtaining accurate network performance metrics, using the obtained metrics to determine whether the network performance meets service level agreements (SLAs), and/or, if necessary, modifying the network infrastructure. For example, a service provider may monitor user-available network bandwidths associated with communication services, determine whether the monitored bandwidths and the latencies meet the requirements specified in the SLAs with the subscribers, and reconfigure the network (e.g., upgrade network devices or software).

### BRIEF DESCRIPTION OF THE DRAWINGS

FIG. 1 illustrates concepts described herein.

FIG. 2 illustrates an exemplary network environment in which systems and methods described herein may be implemented.

FIG. 3 depicts exemplary Fifth Generation (5G) core network components, according to an implementation.

FIG. 4 shows a diagram illustrating example messages exchanged between different components of a network to perform, per Quality-of-Service (QoS) flow, for either an uplink or a downlink QoS measurement.

FIG. 5A illustrates example formats of information exchanged between a User Plane Function (UPF) in a 5G core network and an access network to perform, per QoS flow, downlink QoS measurements, according to an implementation.

FIG. 5B illustrates example formats of information exchanged between a UPF and an access network to perform, per QoS flow, uplink QoS measurements, according to an implementation.

FIG. 6 shows a diagram illustrating example messages exchanged between different components of a network to perform, per service flow, for either an uplink or a downlink QoS measurement.

FIG. 7A illustrates example formats of information exchanged between a UPF and an access network to perform, per service flow, downlink QoS measurements, according to an implementation.

FIG. 7B illustrates example formats of information exchanged between a UPF and an access network to perform, per service flow, uplink QoS measurements, according to an implementation.

FIG. 8 is a flow diagram of an example process that is associated with performing downlink QoS measurements per service flow, according to an implementation.

FIG. 9 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may be a cellular network. A cellular network may be uniquely identified by a Public Land Mobile Network (PLMN) Identifier (ID).

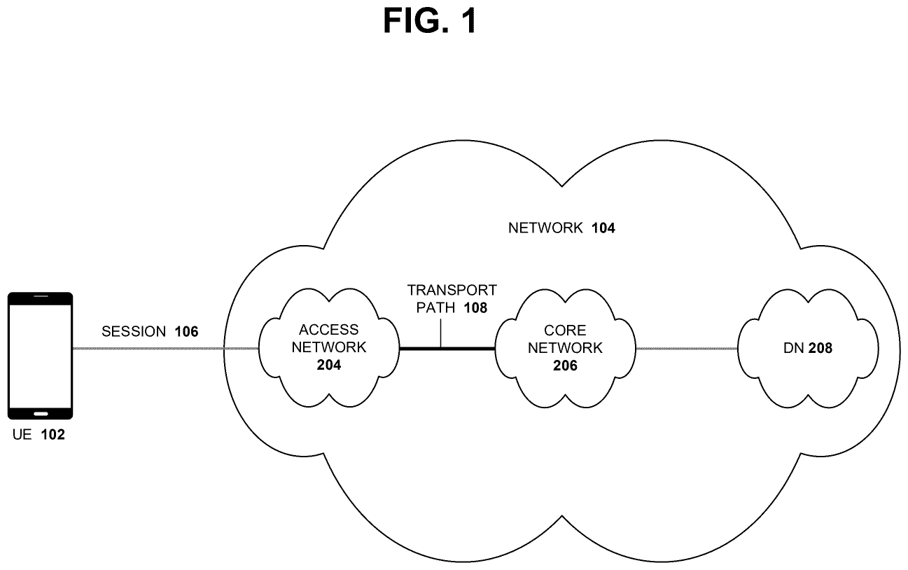

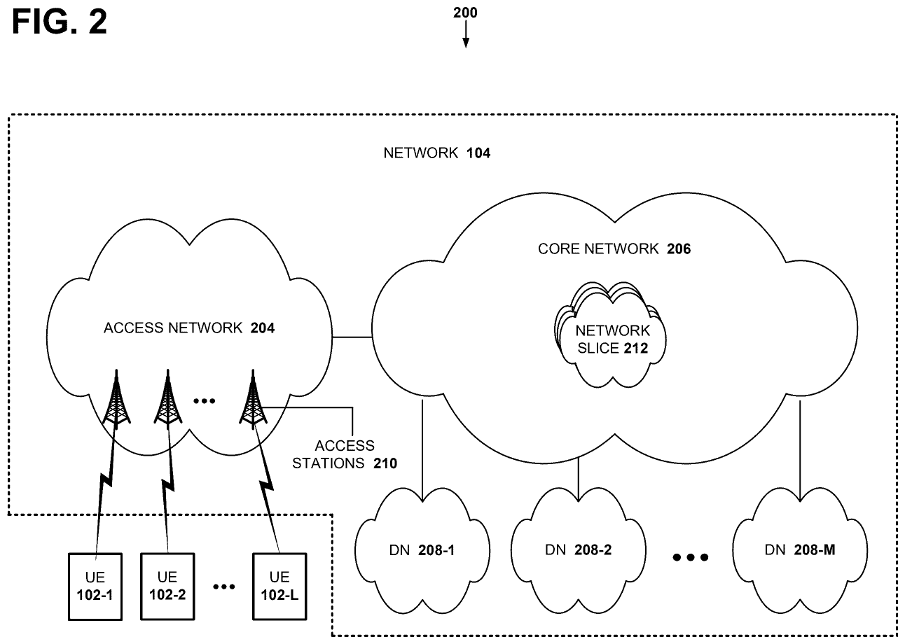

Systems and methods described herein relate to Quality-of-Service (QoS) performance measurements in a provider network, and more specifically, to QoS measurements on protocol data units (PDUs) per service flow, as well as QoS measurements per QoS flow. FIG. 1 illustrates concepts described herein. In FIG. 1, after User Equipment device (UE) 102 registers with provider network 104 (or simply network 104), UE 102 establishes a session with network 104. The session is held over a data path 106 that extends from an application on UE 102 to a point in network 104, such as an application hosted on a data network (DN) 208 (to be described below with reference to FIG. 2). As shown, data path 106 includes access network 204, core network 206, and DN 208.

When an application on UE 102 establishes a service flow with an application in network 104, the service flow is bundled together with other service flows in a QoS flow. Furthermore, QoS flows are then packaged into a PDU session that extends from UE 102 to core network 206. Whereas a PDU session's termination point is at core network 206, the service flow may extend beyond core network 206, to the application hosted on DN 208.

The PDU session from UE 102 to core network 206 is maintained via different underlying protocols over different portions data path 106. For example, from UE 102 to access network 204, the PDU session is maintained over a Radio Resource Control (RRC) connection between UE 102 and access network, whereas from access network 204 to core network 206, the PDU session is maintained over a General Packet Radio Service (GPRS) Tunneling Protocol-User Plane (GTP-U) tunnel. That is, over transport path 108, the PDU session is maintained over a GTP-U tunnel.

When determining the overall QoS performance (e.g., delay/latency) of data traffic between UE 102 and DN 208, it may be important to obtain accurate measurements for packets over transport path 108, between access network 204 and core network 206. Because of its importance, many systems provide mechanisms for measuring QoS performance of packets that belong to a single QoS flow within the PDU session. QoS monitoring focuses on measuring the uplink or downlink data transport QoS performance between access network 204 and core network 206 per QoS Flow of UE 102.

In many scenarios, QoS measurements per QoS flow may not provide sufficient information to pinpoint network issues or to tune network configurations. As indicated above, each QoS flow may comprise one or more service flows, and each service flow may have different characteristics. Accordingly, given the same network capability and load, each service flow may experience different QoS (e.g., different latencies). For example, a tethering data service flow may have less latency than a video streaming service flow. Thus, to better analyze network performance, it may be important to measure QoS performance not only per QoS flow, but per service flow. The systems and methods described herein implement mechanisms for performing such per service flow (as well as per QoS flow) measurements.

FIG. 2 illustrates an exemplary network environment 200 in which the systems and methods described herein may be implemented. As shown, network environment 200 may include UEs 102-1 through 102-L (collectively referred to as UEs 102 and generically referred to as UE 102), access network 204, core network 206, and data networks (DNs) 208-1 through 208-M (collectively referred to as data networks 208 and generically as data network 208). Access network 204, core network 206, and data networks 208 may be part of provider network 104.

UEs 102 may include a wireless communication device capable of Fourth Generation (4G) (e.g., Long-Term Evolution (LTE)) communication, Fifth Generation (5G) New Radio (NR) communication, and/or other wireless communication. Examples of UE 102 include: a Fixed Wireless Access (FWA) device; a Customer Premises Equipment (CPE) device with 4G and 5G capabilities; a smart phone; a tablet device; a wearable computer device (e.g., a smart watch); a global positioning system (GPS) device; a laptop computer; a media playing device; a portable gaming system; an autonomous vehicle navigation system; a sensor; and an Internet-of-Things (IoT) device. In some implementations, UE 102 may include a wireless Machine-Type-Communication (MTC) device that communicates with other devices over a machine-to-machine (M2M) interface, such as LTE-M or Category M1 (CAT-M1) devices and Narrow Band (NB)-IoT devices.

UEs 102 may be associated with a user that is subscribed to network 104 to receive various services. As indicated above, UE 102 may bundle its service flows as a QoS flow and then package its QoS flows as part of a PDU session whose endpoints include UE 102 and a node in core network 206. The service flow may extend from UE 102 to a point beyond the node in core network 206, such as an application hosted on DN 208 or a network slice 212.

Access network 204 may facilitate UE 102's connection to core network 206 by establishing and managing over-the-air channels with UE 102 and backhaul channels with core network 206. These channels enable the relay of information between UE 102 and core network 206. Access network 204 comprises LTE, 5G NR, or other advanced radio access networks, featuring components such as central units (CUs), distributed units (DUs), radio units (RUs), and/or base stations. These network components are illustrated in FIG. 2 as access stations 210 (herein generically referred to as access station 210) for establishing and maintaining over-the-air channel with UEs 102. In some implementations, access station 210 may include a 4G, 5G, or another type of base station (e.g., evolved Node B (eNB), next generation Node B (gNB), etc.) that comprises one or more radio frequency (RF) transceivers. In some implementations, access station 210 may be part of an evolved Universal Mobile Telecommunications Service (UMTS) Terrestrial Radio Access Network (eUTRAN).

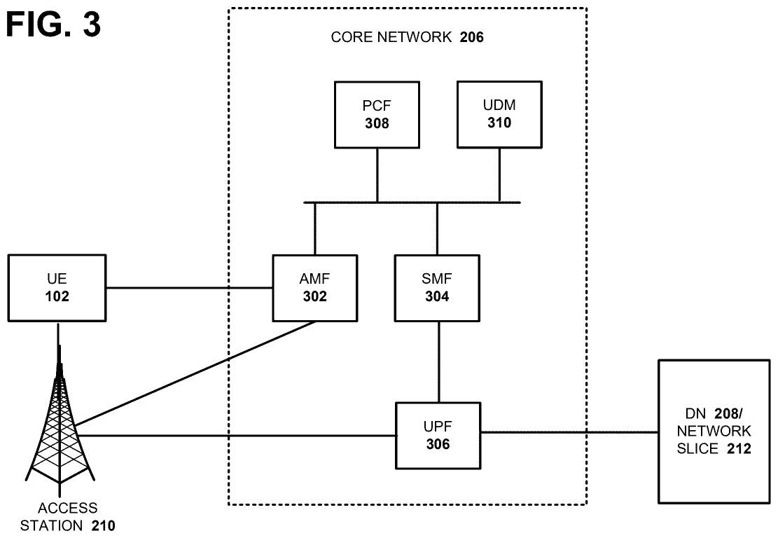

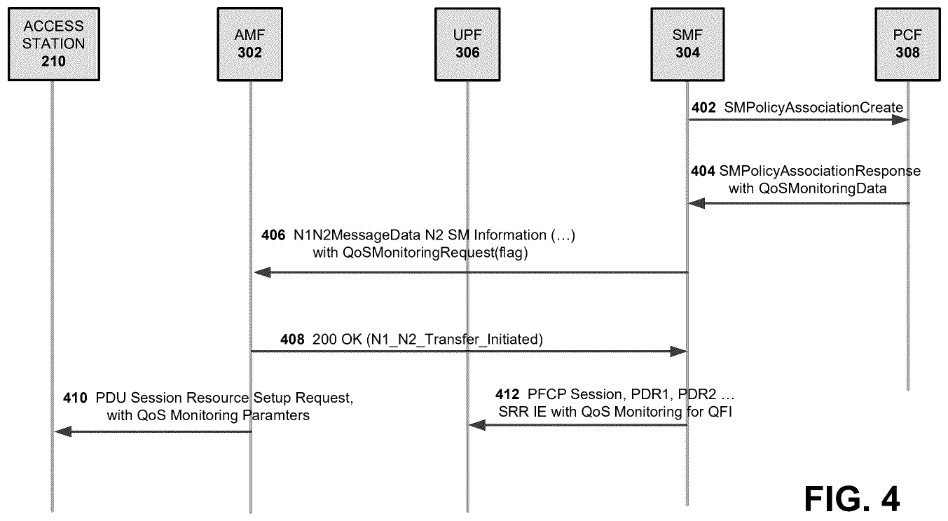

Each access station 210 may function as one of the endpoints of a GTP-U tunnel between access network 204 and core network 206. The other endpoint may include a core network component referred to as a User Plane Function (UPF) (to be described in greater detail with reference to FIGS. 3-7B). Also, as explained in greater detail with reference to FIGS. 4-7B, as part of access network 204, access station 210 may support core network 206 in measuring transport path QoS performance, per QoS flow and/or per service flow.

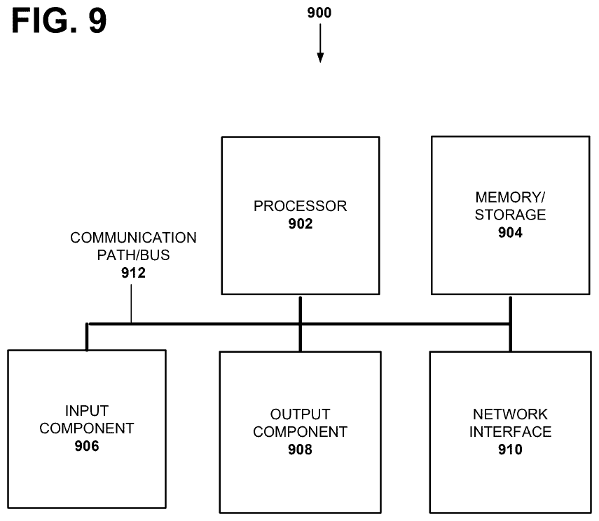

Core network 206 may oversee communication sessions for subscribers connecting via access network 204. For instance, core network 206 may facilitate the establishment of Internet Protocol (IP) connections between UEs 102 and data networks 208. The components within core network 206 can be either dedicated hardware elements or virtualized functions operating atop a shared physical infrastructure using Software Defined Networking (SDN). An SDN controller, for example, may leverage an adapter to implement one or more core network components through virtualized entities like virtual network functions (VNF) virtual machines, Cloud Native Function (CNF) containers, event-driven serverless architecture interfaces, or other SDN components. This shared physical infrastructure may include devices 900, as described below with reference to FIG. 9, within a cloud computing center associated with core network 206. Moreover, core network 206 may encompass 5G core network components, 4G core network components, or other types of core components. Further elaboration on some of these components is provided below with reference to FIG. 3. In addition, some of these components implement part of systems and methods for measuring QoS performance transport networks, on per QoS flow basis or on per service flow basis. Operations of these components for supporting QoS measurements over the transport network, on per QoS flow basis or on per service flow basis, are described in greater detail with reference to FIGS. 3 through 7B.

As further shown, core network 206 may include one or more network slices 212. Depending on the embodiment, network slices 212 may be implemented within other networks, such as access network 204 and/or data network 208. Access network 204, core network 206, and data networks 208 may include multiple instances of network slices 212 (generically or individually referred to as network slice 212). Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport network components, Central Processing Unit (CPU) cycles, memory, etc. Furthermore, each network slice 212 may be configured to meet a different set of requirements and may be associated with a particular QoS Class Identifier (QCI), a type of service, a 5G QoS Identifier (5Q1), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example.

Each network slice 212 may be associated with an identifier, herein referred to as a Single Network Slice Selection Assistance Information (S-NSSAI) and/or a network slice instance ID. Each UE 102 that is configured to access a particular network slice 212 may be associated with corresponding data, stored in core network 206 for example, which includes the S-NSSAI that identifies the network slice 212.

Data networks 208 may include one or more networks connected to core network 206. In some implementations, a particular data network 208 may be associated with a data network name (DNN) in 5G and/or an Access Point Name (APN) in 4G. UE 102 may request a connection to data network 208 using a DNN or APN. In a 5G network, data network 208 that is implemented on network slice 212 may nonetheless be associated with a DNN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 208 may include an application server (also referred to as application). An application may render services to other applications running on UEs 102 and may establish communication sessions with UEs 102 via core network 206.

For clarity, FIG. 2 does not show all components that may be included in network environment 200 (e.g., routers, bridges, wireless access points, additional networks, additional access stations 210, data centers, portals, etc.). Depending on the implementation, network environment 200 may include additional, fewer, different, or a different arrangement of components than those illustrated in FIG. 2.

FIG. 3 depicts exemplary 5G core network components 302-310 in core network 206 according to an implementation. As indicated above, one or more of 5G core network components 302-310, in conjunction with other network components, may implement systems and methods for QoS measurements in transport network per QoS flow basis and/or per service flow basis. As shown, core network 206 may include an Access and Mobility Management Function (AMF) 302, a Session Management Function (SMF) 304, a UPF 306, a Policy Control Function (PCF) 308, and a Unified Data Management (UDM) 310. Although core network 206 is depicted as including network components 302-310 in FIG. 3, in other implementations, core network 206 may include additional, fewer, and/or different 5G core network components than those illustrated in FIG. 3. For example, core network 206 may further include an Authentication Server Function (AUSF), a Charging Function (CHF), a Network Slice Selection Function (NSSF), a Network Exposure Function (NEF), a Network Repository Function (NRF), a Network Data Analytics Function (NWDAF), an Application Function (AF), a Unified Data Repository (UDR), etc.

AMF 302 may perform registration management, connection management, reachability management, mobility management, lawful intercepts, Short Message Service (SMS) transport between UE 102 and a Short Message Service Function (SMSF), session management messages transport between UE 102 and SMF 304, access authentication and authorization, location services management, functionality to support non-Third Generation Partnership Program (3GPP) access networks, and/or other types of management processes. In addition, AMF 302 may include one or more components for supporting the QoS measurements of uplink and/or downlink traffic over a transport network, on per QoS flow basis and/or on per service flow basis. In particular, when AMF 302 receives a session request from UE 102, AMF 302 may send a request to establish a session to SMF 304. Next, SMF 304 may return a reply that includes a N1N2 Message Container (or N1N2 Message Data), N2 Session Management (SM) information, and a Session Resource Setup Request Transfer Information Element (IE). The IE may include, for example, a PDU session ID, a QoS Flow ID (QFI), a QoS profile (e.g., 5Q1), and per QoS flow parameters. The per QoS flow parameters may identify parameters associated with monitoring the QoS performance over the transport network, such as a QoS Monitoring Flag (indicating whether a monitoring on per QoS flow is to be performed), an indication whether an uplink and/or downlink QoS flow is to be monitored. In some implementations, the reply may also include an indication of whether monitoring is to be performed on per service flow basis. AMF 302 may receive the reply over a standard interface (e.g., N11 interface) or a modified form of the standard interface.

After the receipt of the reply from SMF 304, AMF 302 may then send a Next Generation Application Protocol (NGAP) message to access station 210 over N2 interface. The message may include, for example, a PDU Session Resource Setup request, a PDU session ID, N2 SM information, and QoS monitoring parameters that AMF 302 extracted from the reply from SMF 302. In some implementations, the NGAP message may also include parameters pertaining to per service flow monitoring.

SMF 304 may perform session establishment, session modification, and/or session release, perform IP address allocation and management, perform Dynamic Host Configuration Protocol (DHCP) functions, perform selection and control of UPF 306, configure traffic steering at UPF 306 to guide the traffic to the correct destinations, terminate interfaces toward PCF 308, perform lawful intercepts, charge data collection, support charging interfaces, control and coordinate charging data collection, terminate session management parts of Non-Access Stratum (NAS) messaging, perform downlink data notification, manage roaming functionality, and/or perform other types of control plane processes for managing user plane data.

During its operations to set up a PDU session, SMF 304 may send an SM Policy Association Create message (or SMPolicyAssociationCreate message) to PCF 308 over a standard interface (e.g., N7 interface). In response, PCF 308 may send a reply that includes a session rule and one or more Policy and Charging Control (PCC) rules. The PCC rules may comprise, for example, a default PCC rule, a rule for video streaming, a rule for voice (e.g., VOIP), etc. The PCC rules may also include QoS monitoring parameters, such as whether a monitoring is to be performed on per QoS flow basis or on per service flow basis, an indication of whether QoS monitoring is to be performed for a particular service, etc.

When SMF 304 interacts with UPF 306 to establish a PDU session, SMF 304 may conduct a Packet Forwarding Control Protocol (PFCP) session over N4 interface. During the PFCP session, SMF 304 may forward one or more packet detection rules (PDRs) and Session Report Request (SRR) Information Element (IE). Each PDR may specify packet filters, a QFI, a forwarding action rule, a QoS enforcement rule, a usage reporting rule, etc. the SRR IE may specify information to be reported by UPF 306, such as QoS monitored parameters (e.g., QoS measurements per QoS flow or per service flow). In some implementations, the SRR IE may be part of a PDR, rather than an item separate from PDRs.

UPF 306 may maintain an anchor point for intra/inter-Radio Access Technology (RAT) mobility, maintain an external PDU point of interconnect to a particular data network (e.g., data network 208), perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a RAN node (e.g., access station 210), and/or perform other types of user plane processes.

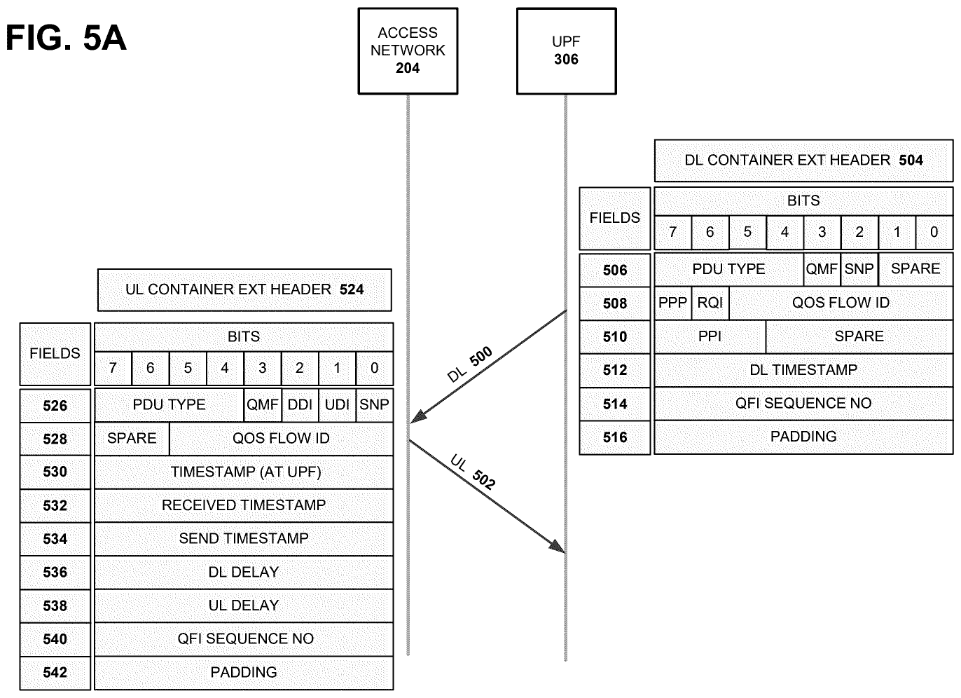

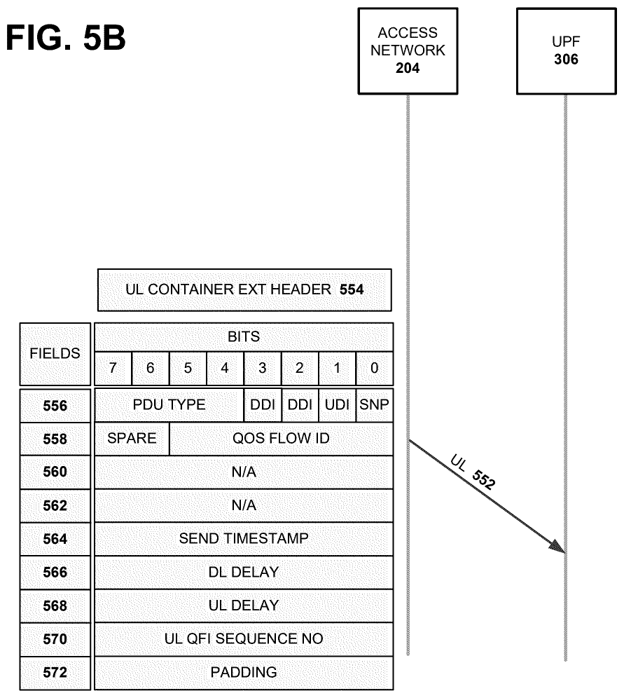

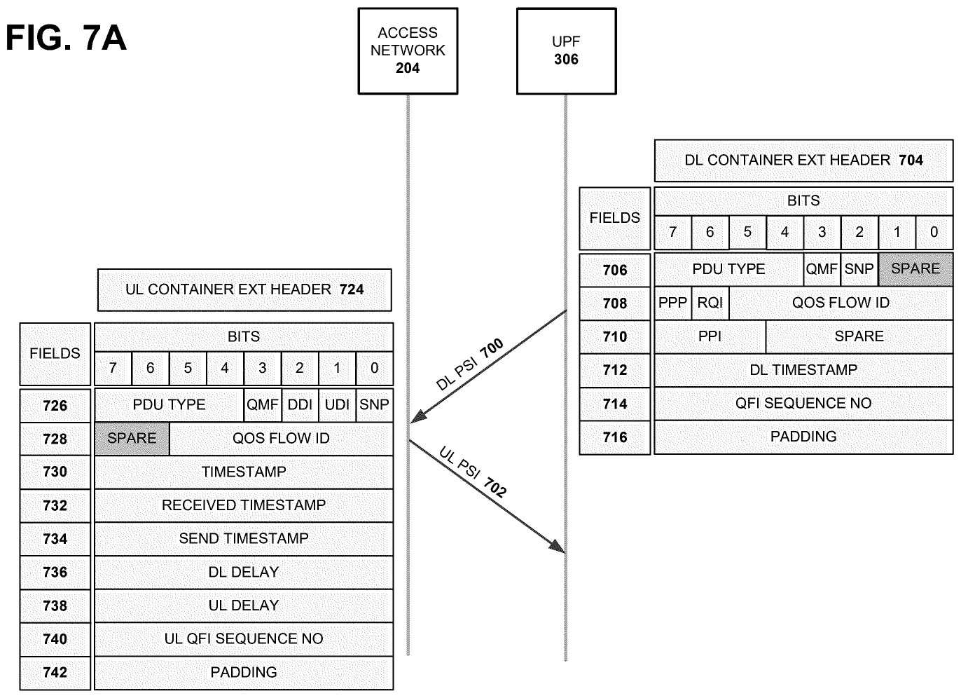

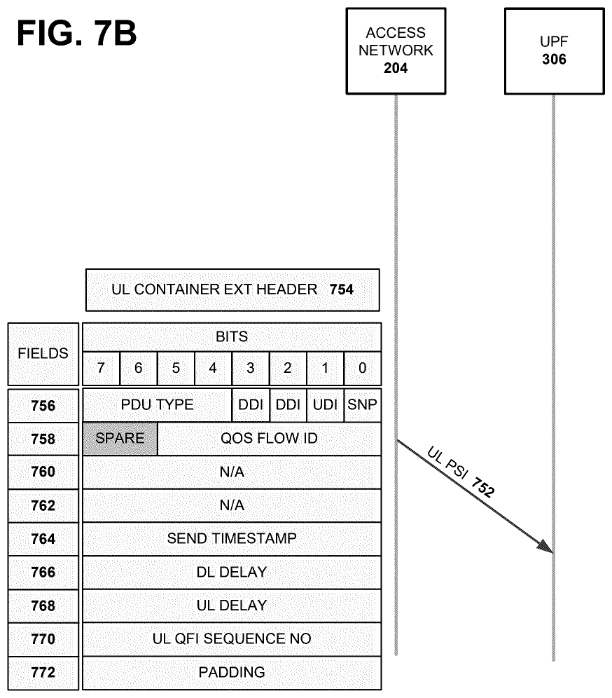

When UPF 306 receives PDRs and SRR IE from SMF 304 over a PFCP session with SMF 304, UPF 306 may use part of the PDRs and/or SRR IE to perform QoS monitoring (uplink and/or downlink) on per QoS flow basis or per service flow basis. UPF 306's operations for measuring QoS performance on per QoS flow basis (in response to the PDRs and/or the SRR IE) is described below with reference to FIGS. 5A and 5B; and UPF 306's operations for measuring QoS performance on per service flow basis is described below with reference to FIGS. 7A and 7B.

PCF 308 may support policies to control network behavior, provide policy rules to control plane functions (e.g., to AMF 302, SMF 304, etc.), access subscription information relevant to policy decisions, make policy decisions, and/or perform other types of processes associated with policy enforcement. As described above, when PCF 308 receives an SM Policy Association Create message from SMF 304, PCF 308 may provide a response that includes a session rules and one or more PCC rules.

UDM 310 may maintain subscription information for UEs 102, manage subscriptions, generate authentication credentials, handle user identification, perform access authorization based on subscription data, perform network function registration management, maintain service and/or session continuity by maintaining assignment of SMF 304 for ongoing sessions, support SMS delivery, support lawful intercept functionality, and/or perform other processes associated with managing user data. UDM 310 may store the data that it manages in a UDR. The UDR may include subscription data associated with the subscribers of network services (e.g., users of UE 102), policy data, and application data. The policy data may include policy rules and parameters associated with the policy rules. The application data may comprise information and/or data collected by applications.

FIG. 4 shows a diagram illustrating example messages exchanged between different components of a network to perform, per QoS flow, either an uplink or a downlink QoS measurements. More specifically, FIG. 4 illustrates messages exchanged between access station 210 in FIG. 4), AMF 302, SMF 304, UPF 306, and PCF 308. Assume that AMF 302 received a session request from UE 102 and that AMF 302 sent a request to establish a PDU session to SMF 304.

When SMF 304 receives the request to establish a PDU session from AMF 302, SMF 304 may send an SM Policy Association Create request to PCF 308 (arrow 402). The message may be sent via N7 interface, for example. In response, PCF 308 may send a reply (SM Policy Association Response) (arrow 404). The response may include a session rule and PCC rules. The PCC rules may include (in addition to other information) QoS monitoring parameters. QoS monitoring parameters may include information such as whether a monitoring is to be performed on per QoS flow basis or on per service flow basis, an indication of the QoS for a particular service (e.g., 5Q1), etc. SMF 304 may receive the information over a standard interface or a modified interface.

Next, SMF 304 may invoke N1N2 Message Data N2 SM Information ( . . . ) call to AMF 302 (arrow 406). The call may include a QoS monitoring Request flag. When AMF 302 is about to transfer session related information to access station 210, AMF 302 may send a reply to SMF 304 with an OK message (arrow 408), indicating that session-related information is about to be sent to access station 210 over N2 interface. When SMF 304 receives the OK reply, SMF 304 may interact with UPF 306 to establish a session. More specifically, SMF 304 may conduct a PFCP session over N4 interface (arrow 412). During the PFCP session, SMF 304 may forward one or more packet detection rules (PDRs) and Session Report Request (SRR) Information Element (IE). Each PDR may specify packet filters, a QFI, a forwarding action rule, a QoS enforcement rule, a usage reporting rule, etc. The SRR IE may specify information to be reported by UPF 306, such as QoS monitored parameters (e.g., QoS measurements per QoS flow or per service flow).

When AMF 302 receives N1N2 Message Data call, AMF 302 may also send a PDU Session Resource Setup request to access station 210, together with QoS monitoring parameters (arrow 410). Depending on the implementation, QoS monitoring parameters may indicate per QoS flow monitoring request, a QoS flow ID, per service flow monitoring request, a service ID, etc.

FIG. 5A illustrates example formats of information exchanged between UPF 306 and access station 210 (as part of access network 204) to perform, on a per QoS flow basis, for downlink QoS measurements. After the exchange of messages illustrated in FIG. 4 (e.g., after UPF 306 exchanges information with SMF 304 over the PFCP session and after access station receives PDU session resource setup request from AMF 302), UPF 306 may establish a GTP-U tunnel with an access station 210. UPF 306 and access station 210 may thus maintain a portion of a PDU session over transport path 108 via GTP-U tunnel.

After the establishment of the GTP-U tunnel, UPF 306 may send downlink packets to access station 210 over the GTP-U tunnel, where each packet is encapsulated in a GTP-U PDU session container. If UPF 306 has been notified by SMF 304 to monitor QoS per QoS flow, UPF 306 may select some of the packets to be sent over the GTP-U tunnel in GTP-U PDU session containers, and generate, for each of the selected packets, an extension header-DL GTP-U PDU session container extension header 404. FIG. 5A shows an example format of PDU session container extension header 504 for downlink (DL) path 500.

As shown, for a downlink, GTP-U PDU session container extension header 504 may include: for fields 506, spare bits (bits 0 and 1), a sequence number present (SNP) bit, a QoS Monitoring Flag (QMF) bit, and a PDU type field/bits (bits 4-7); for field 508, a QoS flow ID field (bits 0-5), a reflective QoS indicator (RQI) bit/field (bit 6), and a Packet Processing Priority (PPP) bit (bit 7); for fields 510, spare bits (bits 0-4) and a paging policy indicator (PPI) field (bits 5-7); for fields 512, a sending timestamp field; for fields 514, a QFI sequence number field; and for fields 516, a padding field.

The spare bits in fields 506 may be used for a particular purpose by a service provider or they may be reserved bits. The SNP bit may indicate whether the QFI sequence number (fields 514) is present. The QMF bit may indicate whether the monitoring is to be (or is being) performed on the packet. Given that SMF 304 has indicated that UPF 306 monitor QoS performance on per QoS flow basis, the QMF flag is set to 1. The PDU type field specifies the type of PDU (e.g., IPv6, IPv4, Ethernet frame, etc.). The QoS flow ID field may specify the QoS flow to which the packet belongs. The RQI field may indicate whether UE 102 may use Reflective QoS, which ensures that downlink packets receive the same QoS treatment as corresponding uplink packets without requiring explicit signaling for each flow. The PPP may indicate the priority for processing the packet. The spare bits in fields 510 may include unused bits. The PPI field may indicate paging related information. The sending timestamp field (shown as DL Timestamp in FIG. 5A) may include a timestamp for the time when the packet is sent from UPF 306. The QFI sequence number field indicates the sequence number of the packet within the QoS flow (specified by QFI). The padding field adds octets to fill out the extension header.

When access station 210 receives the selected packets with the GTP-U PDU session container extension headers (among other packets it receives) over the GTP-U tunnel, access station 210 may generate a reporting packet for UPF 306 (e.g., a copy of the packet associated with an extension header) received from UPF 306), generate a new extension header for the reporting packet, and then forward the GTP-U PDU session container (with the reporting packet in the container) to UPF 306. As shown, the extension header for the reporting packet (shown in FIG. 5A as UL Container extension header 524) may include: for fields 526, an SNP bit (bit 0), an uplink delay indicator (UDI) bit (bit 1), a downlink delay indicator (DDI) bit (bit 2), a QMF bit (bit 3), and a PDU type field (bits 4-7); for fields 528, a QoS flow ID field (bits 0-5) and spare bits (bits 6-7); for fields 530, the timestamp provided in the packet that UPF 306 sent to access station 210 for QoS monitoring; for fields 532, the receive timestamp field; for fields 534, a send time stamp field; for fields 536, a downlink (DL) delay field; for fields 538, an uplink (UL) delay field; for fields 540, a QFI sequence number field; and for field 542, a padding field.

The SNP bit in fields 526 may indicate whether fields 440 (QFI sequence number field) is present in the extension header. The UDI bit may indicate whether fields 538 (UL delay field) is present in the extension header. The DDI bit may indicate whether fields 536 (DL delay field) is present in the extension header. The QMF bit may carry the value of the QMF bit of the corresponding selected packet, from UPF 306, which triggered the generation of the reporting packet. The PDU type field may indicate the type of packet in the container, similar to extension header 504. The QoS flow ID field may specify the QoS flow ID to which the packet belongs. The spare bits in fields 528 complete the octet of fields 528. The timestamp of fields 530 may repeat the timestamp provided in the extension header of the selected packet, which UPF 306 sent to access station 210 and triggered the reporting packet. The receive timestamp field may specify the time at which the packet, which triggered the generation of the reporting packet, was received at access station 210. The send time stamp may bear the timestamp of the time at which the reporting packet is sent (or to be sent) to UPF 306. The downlink delay field may specify the delay associated with the packet traversal from UPF 306 to access station 210. The uplink delay field may include the uplink time delay, which, if not known, may not be present (e.g., UDI may be set to zero). The QFI sequence number field may include the sequence number of the packet within the QoS flow identified by the QFI. The padding field may fill out the extension header.

When UPF 306 receives the reporting packet from access station 210, UPF 306 may record the time of receipt of the reporting packet. Next, UPF 306 may use the recorded time and the timestamps in the extension header of the reporting packet to calculate the downlink delay. Assume that T1 denotes the value of the timestamp of field 530 (e.g., recorded in milliseconds since a reference time), T2 denotes the value of the timestamp of field 532, T3 denotes the value of the time stamp of field 534, and T4 denotes the time of receipt of the reporting packet at UPF 306. Then the downlink delay can be calculated as T2-T1. In addition, the average traversal time of a packet to/from UPF 306 to/from access station may be calculated as Delay=(T2−T1)+(T4−T3))/2. Upon completing such calculations for each of the reporting packets (which correspond to the packets selected by UPF 306 for QoS performance measurement on per QoS flow basis), UPF 306 may send the results to a storage along with other information (e.g., the QFI of the QoS flow for which the QoS measurements are made) for further analysis. For example, UPF 306 may send the results to an Operations Administrations and Maintenance (OAM) system.

FIG. 5B illustrates example formats of information exchanged between UPF 306 and access station 210 (as part of access network 204) to perform, on per QoS flow basis, for UL QoS measurements. Assume that after exchanging information with SMF 304 over the PFCP session, UPF 306 has established a GTP-U tunnel with access station 210. UPF 306 and access station 210 may thus maintain a portion of a PDU session over transport path 108 via GTP-U tunnel.

For the uplink depicted in FIG. 5B, rather than receiving selected downlink packets for QoS measurements per QoS flow from UPF 306 to trigger generating reporting packets, access station 210 may receive uplink packets from UE 102. Upon receipt of the packets, access station may select a number of packets for QoS measurements for a specified QFI, then place the selected packet in the GTP-U PDU packet container with extension headers (shown in FIG. 5B as UL container extension header 554) and send the container to UPF 306. As shown, extension header 554 may include fields 556-572. These fields include the same types of information as fields 526-542. In contrast to fields 530 and 532, fields 560 (which would correspond to fields 530) and fields 562 (which would correspond to fields 532) are not present in extension header 554.

When UPF 306 receives the containers (and the packets selected by access station 210 for per QoS flow monitoring) from access station 210 over an uplink path 552, for each of the received packets, UPF 306 may record the time of the receipt. Next, UPF 306 may extract the time of the transmission of the container at access station 210 by examining extension header 554 (e.g., the timestamp of fields 564). Assuming that T4 denotes the time of receipt of the container and that T3 denotes the time of the transmission, the delay for the packet can be calculated as: Delay=T4−T3. Upon completing the calculations for each of the packets selected by access station 210, UPF 306 may send the results (along with the QFI and other parameters) to a storage or to an OAM system for further analysis.

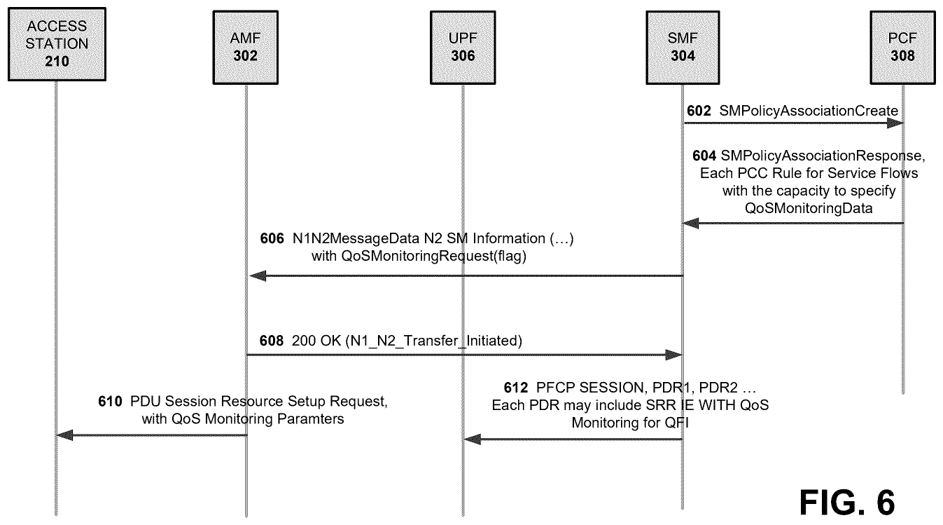

FIG. 6 shows a diagram illustrating example messages exchanged between different components of a network to perform, per service flow, either an uplink or a downlink Qos measurements. Similar to FIG. 4, FIG. 6 illustrates messages exchanged between access station 210, AMF 302, SMF 304, UPF 306, and PCF 308. As in FIG. 4, Assume that AMF 302 received a session request from UE 102 and that AMF 302 sent a request to establish a PDU session to SMF 304.

In FIG. 6, access station 210, AMF 302, SMF 304, UPF 306, and PCF 308 exchange the same types of messages as messages 402-412 in FIG. 4. However, to set up per service flow QoS monitoring over path 108, access station 210, AMF 302, SMF 304, UPF 306, and/or PCF 308 may include interface modifications or modifications in logic. That is, in FIG. 6, at least for some of the messages 602-612, access station 210, AMF 302, SMF 304, UPF 306, and PCF 308 may use different or modified interfaces in order to signal per service flow QoS monitoring.

For example, when PCF 308 receives a SM Policy Association Create message 602 from AMF 302, PCF 308 may provide a reply 604 that includes an indication of per service flow QoS monitoring. Depending on the implementation, either the format of PCC rules are expanded to indicate per service flow QoS monitoring (for uplink and/or downlink) or alternatively, the response itself includes additional data that indicates per service flow QoS monitoring requirements.

In another example, when SMF 304 signals AMF 302 with N1N2 Message Data (arrow 606), it may provide additional data (that is, in addition to standard SM information) that signals per service flow QoS monitoring, over modified N11 interface. Alternatively, SMF 304 may use a standard interface but pass data with a different format that indicates per service flow QoS monitoring, for uplink and/or downlink communication. Similarly, when AMF 302 passes PDU Session Resource Setup request to access station 210 (arrow 610), the QoS monitoring parameters may include additional information indicating whether per service flow QoS monitoring is to be performed, for uplink and/or downlink data transport. Furthermore, when SMF 304 conducts a PFCP session with UPF 306 to set up a PDU session (arrow 612), SMF 304 may send PDRs that specifies per service flow QoS monitoring for different services (e.g., Internet service, VOIP service, a gaming service, a graphics generation service, etc.).

FIG. 7A illustrates example formats of information exchanged between UPF 306 and access station 210 (as part of access network 204) to perform QoS monitoring, on per service flow basis, for downlinks communications. After the exchange of messages illustrated in FIG. 6 (e.g., after UPF 306 exchanges information with SMF 304 over the PFCP session and after access station receives PDU session resource setup request from AMF 302), UPF 306 may establish a GTP-U tunnel with an access station 210. UPF 306 and access station 210 may thus maintain a PDU session over transport path 108 via GTP-U tunnel.

Similar to what has been described above with respect to FIG. 5A, after the establishment of the GTP-U tunnel, UPF 306 may send downlink packets to access station 210 over the GTP-U tunnel, where each packet is encapsulated in a GTP-U PDU session container. If UPF 306 has been notified by SMF 304 to monitor QoS, on per service flow basis, UPF 306 may select a subset of the packets that belong to the same service flow (and the same QoS flow) to be sent over the GTP-U tunnel in GTP-U PDU session containers, and generate, for each of the selected packets, an extension header-DL GTP-U PDU session container extension header 704. FIG. 7A shows an example format of PDU session container extension header 704 for downlink (DL) path 700.

In FIG. 7A, fields 706-716 comprise the same types of information as fields 506-516 of extension header 504, except that one or more fields 706-716 indicate per service flow monitoring. For example, in one implementation, the spare bits in fields 706 may indicate per service flow monitoring and the QMF bit in fields 706 is set to 0 to indicate that there is no monitoring on per QoS flow basis. Because the packets that are selected to be sent by UPF 306 belong to the same service flow and the same QoS flow, all extension headers of the selected packets include similar or the same QoS flow-related information.

When access station 210 receives the UPF 306-selected packets, with the GTP-U PDU session container extension headers (among other packets it receives), over the GTP-U tunnel, access station 210 may generate reporting packets for the UPF 396 (e.g., a copy of the packet. Each of the reporting packets may be placed in a GTP-U PDU session container with new GTP-U session container extension header 724 and then forwarded to UPF 306.

As shown, extension header 724 may include fields 726-742 that comprise the same types of information as fields 526-542 of extension header 524, except that one or more of fields 706-716 may indicate per service flow monitoring. For example, one or more of the spare bits in fields 728 may be set to indicate per service flow monitoring. Additionally, the QMF bit may be set to 0, to indicate that no per QoS flow monitoring is performed.

When UPF 306 receives a reporting packet from access station 210, UPF 306 may record the time of receipt of the reporting packet. Next, UPF 306 may use the recorded time and the timestamps in the extension header 724 associated with the reporting packet to calculate the downlink delay. Assume that T1 denotes the value of the timestamp of fields 730 (e.g., recorded in milliseconds since a reference time), T2 denotes the value of the timestamp of fields 732, T3 denotes the value of the time stamp of fields 734, and T4 denotes the time of receipt of the reporting packet at UPF 306. Then the downlink delay can be calculated as T2−T1. In addition, the average traversal time of a packet to/from UPF 306 from/to access station can be calculated as Delay=(T2−T1)+ (T4−T3))/2. Upon completing such calculations for each of the reporting packets (which correspond to the packets selected by UPF 306 for per service flow QoS measurement), UPF 306 may send the results to a storage or report the results to an OAM system.

FIG. 7B illustrates example formats of information exchanged between UPF 306 and access station 210 (as part of access network 204) to perform, on per service flow basis, UL QoS measurements. Assume that after exchanging information with SMF 304 over the PFCP session, UPF 306 has established a GTP-U tunnel with access station 210. UPF 306 and access station 210 may thus maintain a PDU session over transport path 108 via GTP-U tunnel.

Similar to what has been described above for FIG. 5B, for the uplink situation depicted in FIG. 7B, rather than receiving selected downlink packets for QoS measurements per service flow from UPF 306 and generating reporting packets, access station 210 may receive uplink packets from UE 102. Upon receipt of the packets, access station may select a number of the received packets for QoS measurements for a specified service flow (which UPF 306 is aware of), then place the selected packets in GTP-U PDU packet containers with extension headers (shown in FIG. 7B as UL container extension header 754) and send the packets to UPF 306. Packets that are not selected are also sent in containers, but without extension headers.

As shown, extension header 754 may include fields 756-772. These fields may comprise the same types of information as fields 726-742. In contrast to fields 730 and 732, however, fields 760 and fields 762 do not carry, respectively, the timestamp of any packet from UPF 306, as no packet is sent from UPF 306 to trigger generating reporting packets.

When UPF 306 receives the containers (and the packets selected by access station 210 for per service flow QoS monitoring) from access station 210 over an uplink path 752, for each of the received packets, UPF 306 may record the time of the receipt. Next, UPF 306 may extract the time of the transmission of the container at access station 210 by examining extension header 754 (e.g., the timestamp of fields 764). Assuming that T4 denotes the time of receipt of the container and that T3 denotes the time of the transmission, the delay for the packet can be calculated as: Delay=T4−T3. Upon completing the calculations for each of the packets selected by access station 210, UPF 306 may send the results (along with the QFI and other parameters to a storage, network operators, and/or an OAM system.

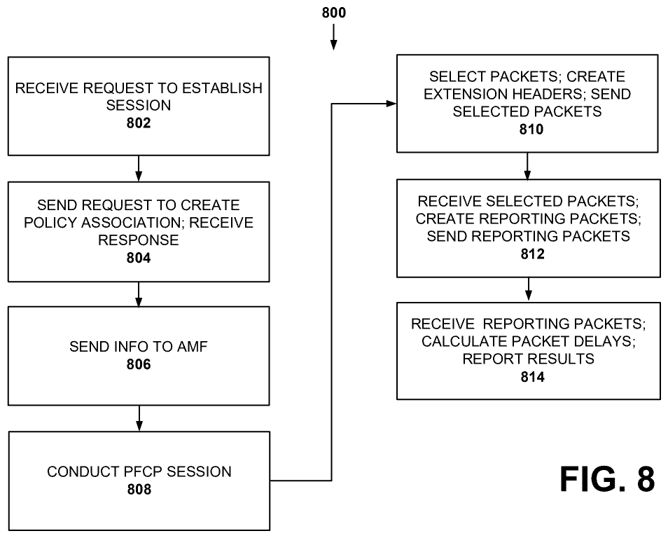

FIG. 8 is a flow diagram of an example process 800 associated with performing downlink QoS measurements on per service flow basis, according to an implementation. Process 800 may be performed by various components of network 104, including those depicted in FIGS. 1-7B. Each block in FIG. 8 is not intended to signify every action performed by the components. As shown, process 800 may include receiving a request to establish a PDU session (block 802). For example, AMF 302 may receive, from UE 102, a request to establish a session. In another example, SMF 304 may receive a request to establish a session from AFM 302.

Process 800 may further include sending a request to create a policy association and receiving a response (block 804). For example, SMF 304 may send a SM Policy Association Create message 402/602 to PCF 308; and receive, from PCF 308, SM Policy Association Response 404/604 from PCF 308. As described above, SM Policy Association Response 404/604 may include parameters related to per QoS flow QoS monitoring and/or per service flow QoS monitoring.

Process 800 may further include sending, to AMF 302, information to be forwarded to access station 210 (block 806). For example, SMF 304 may send N1N2 Message Data, with N2 SM Information. N2 SM information may include information pertaining to per QoS flow QoS monitoring or per service flow QoS monitoring. When AMF 302 receives the data from SMF 304, AMF 302 may send a PDU Session Setup Request, along with information on per QoS flow QoS monitoring or on per service flow QoS monitoring. In addition to sending the data to AMF 302, SMF 304 may conduct a PFCP session with UPF 306 (block 808). During the PFCP session, SMF 304 may exchange information necessary for UPF 306 to set up a PDU session with UE 102. Furthermore, SMF 304 may provide information pertaining to per QoS flow QoS monitoring or per service flow QoS monitoring to UPF 306.

After conducting a PFCP session with SMF 304 and receiving information on per QoS flow QoS monitoring or on per service flow QoS monitoring, UPF 306 may select packets to monitor for QoS over transport path 108 (bock 810). For per QoS flow QoS monitoring, UPF 306 may select packets that are associated with the same QFI; for per service flow monitoring, UPF 306 may select packets that not only bear the same QFI but also originate from the same source (e.g., the same application, the same IP address, etc.). Next, UPF 306 may create, for each of the selected packets, GTP-U PDU session containers and their extension headers (block 810). The contents of the extension headers may include various parameters, such as a QMF (set to 1 for per QoS flow monitoring), spare bits (set for per service flow monitoring), a QFI, a timestamp which indicates the time of transmission of the packet, etc. Thereafter, UPF 306 may send each of the packets (in the containers) along with the extension headers to access station (block 810).

Process 800 may further include receiving the selected packets from UPF 306, creating reporting packets that correspond to the selected packets, and sending the reporting packets (block 812). Each of the reporting packets may be encapsulated in a GTP-U PDU session container, with its own extension header. Each of the extension headers may include, among other things, a timestamp of the time of the receipt of the corresponding selected packet (from UPF 306) and the time of the transmission of the reporting packet to UPF 306, over the GTP-U tunnel between access station 210 and UPF 306. In addition, each of the extension headers may include information such as the spare bits in fields 728, a QMF bit, etc. These have been described above in greater detail with reference to FIGS. 5A and 7A.

Process 800 may further include receiving the reporting packets from access station 210, calculating the packet delays, and reporting the calculated packet delays (block 814). When UPF 306 receives the reporting packets, UPF 306 may record the times of receipt of the reporting packets. Furthermore, UPF 306 may use the recorded times and the timestamps in the extension headers associated with the reporting packets to calculate the downlink delays.

Assume that T1 denotes the value of the timestamp of fields 730 (e.g., recorded in milliseconds since a reference time), T2 denotes the value of the timestamp of fields 732, T3 denotes the value of the time stamp of fields 734, and T4 denotes the time of receipt of the reporting packet at UPF 306. Then the downlink delay can be calculated as T2−T1. In addition, the average traversal time of a packet to/from UPF 306 from/to access station can be calculated as Delay=(T2−T1)+ (T4−T3))/2. Upon completing such calculations for each of the reporting packets, UPF 306 may send the results to a storage or report the results to an OAM system.

FIG. 9 depicts exemplary components of a network device 900. Network device 900 may correspond to or be included in any of the devices and/or components illustrated in FIGS. 1-7B (e.g., network 104, UE 102, access network 204, core network 206, data network 208, access station 210, and core network components 302-310). In some implementations, network devices 900 may be part of a hardware network layer on top of which other network layers and NFs may be implemented.

As shown, network device 900 may include a processor 902, memory/storage 904, input component 906, output component 908, network interface 910, and communication path 912. In different implementations, network device 900 may include additional, fewer, different, or different arrangement of components than the ones illustrated in FIG. 9. For example, network device 900 may include line cards, switch fabrics, modems, etc.

Processor 902 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 900 and/or executing programs/instructions.

Memory/storage 904 may include static memory, such as read only memory (ROM), and/or dynamic memory, such as random access memory (RAM), or onboard cache, for storing data and machine-readable instructions (e.g., programs, scripts, etc.). Memory/storage 904 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 904 may be external to and/or removable from network device 900. Memory/storage 904 may include, for example, a Universal Serial Bus (USB) memory stick, a dongle, a hard disk, off-line storage, a Blu-Ray® disk (BD), etc. Memory/storage 904 may also include devices that can function both as a RAM-like component or persistent storage, such as Intel® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 906 and output component 908 may provide input and output from/to a user to/from network device 900. Input/output components 906 and 908 may include a display screen, a keyboard, a mouse, a speaker, a microphone, a camera, a DVD reader, USB lines, and/or other types of components for obtaining, from physical events or phenomena, to and/or from signals that pertain to network device 900.

Network interface 910 may include a transceiver (e.g., a transmitter and a receiver) for network device 910 to communicate with other devices and/or systems. For example, via network interface 910, network device 900 may communicate over a network, such as the Internet, an intranet, cellular, a terrestrial wireless network (e.g., a WLAN, WIFI, WIMAX, etc.), a satellite-based network, optical network, etc. Network interface 910 may include a modem, an Ethernet interface to a LAN, and/or an interface/connection for connecting network device 900 to other devices (e.g., a Bluetooth interface).

Communication path or bus 912 may provide an interface through which components of network device 900 can communicate with one another.

Network device 900 may perform the operations described herein in response to processor 902 executing software instructions stored in a non-transient computer-readable medium, such as memory/storage 904. The software instructions may be read into memory/storage 904 from another computer-readable medium or from another device via network interface 910. The software instructions stored in memory/storage 904, when executed by processor 902, may cause processor 902 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 4, 5A, 5B, 6, 7A, 7B, and 8. the order of the actions, messages, and signals may be modified in other implementations. In addition, non-dependent actions, messages, and signals may represent actions, messages, and signals that can be performed, sent, and/or received in parallel and in different orders. Furthermore, each of actions, messages, and signals illustrated may include one or more other actions, messages, and/or signals.

As used above, the term “session” may refer to a series of communications, of a limited duration, between two endpoints (e.g., two applications). When a session is established between an application and a network or a network slice, the session is established between the application and another application/server hosted by the network or the network slice. Similarly, if a session is established between a device and a network slice or a network, the session is established between an application on the device and another application on either the network slice or the network.

In addition, the term PDU session (a protocol data unit session) or a PDN session (packet data network session) may refer to communications between a mobile device and another endpoint (e.g., a data network, a network slice, etc.). Depending on the context, the term “session” may refer to a PDU session, a PDN session, or a session between applications. Additionally, depending on the context, the term “connection” may refer to a session, a PDU session, a PDN session, or another type of connection (e.g., a radio frequency link between a device and a base station).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A system comprising:
a first core network component configured to:
receive, from a second core network component, a reply which indicates that a Quality-of-Service (QoS) monitoring is to be performed for a flow associated with a User Equipment device (UE);
provide information to a third core network component to establish a Protocol Data Unit (PDU) session with the UE and monitor the PDU session over a transport network; and
send a message to a fourth core network component that notifies an access station to allocate resources for the PDU session.

2. The system of claim 1, wherein when receiving the reply, the first core network component is configured to:
receive Policy and Charging Control (PCC) rules, wherein the PCC rules include QoS monitoring parameters.

3. The system of claim 1, wherein when providing the information to the third core network component, the first core network component is configured to:
provide a Session Report Request (SRR) information element (IE) that includes QoS monitoring parameters.

4. The system of claim 1, further comprising the third core network component, wherein the third core network component comprises a User Plane Function (UPF), and wherein the UPF is configured to:
select packets, from packets that belong to the flow;
encapsulate each of the selected packets in a General Packet Radio Service Tunneling Protocol-User Plane (GTP-U) PDU session container, with an extension header; and
send the selected packets in the GTP-U PDU session containers to the access station via a GTP-U tunnel between the UPF and the access station.

5. The system of claim 4, further comprising the access station, wherein the access station is configured to:
receive a selected packet from the UPF;
generate a reporting packet based on the received selected packet; and
send the porting packet to the UPF in a GTP-U PDU session container, along with an extension header associated with the reporting packet.

6. The system of claim 4, wherein the UPF is further configured to:
receive, from the access station, a reporting packet that corresponds to the selected packet;
extract, from an extension header associated with the reporting packet, timestamps; and
determine packet delays per flow based on the extracted timestamps and a time of receipt of the reporting packet.

7. The system of claim 4, wherein the extension header includes indications of either per QoS flow monitoring or per service flow monitoring.

8. The system of claim 7, wherein the indications of per service flow monitoring include spare bits in a first octet of the extension header.

9. The system of claim 1, wherein the third core network component includes a User Plane Function (UPF) and wherein the first core network component is further configured to:
conduct a Packet Forwarding Control Protocol (PFCP) session, wherein the first core network component provides parameters for QoS monitoring per service flow over the PFCP session.

10. A method comprising:
receiving, from a first core network component, a reply which indicates that a Quality-of-Service (QoS) monitoring is to be performed for a flow associated with a User Equipment device (UE);
providing information to a second core network component to establish a Protocol Data Unit (PDU) session with the UE and monitor the PDU session over a transport network; and
sending a message to a third core network component that notifies an access station to allocate resources for the PDU session.

11. The method of claim 10, wherein receiving the reply includes:
receiving Policy and Charging Control (PCC) rules, wherein the PCC rules include QoS monitoring parameters.

12. The method of claim 10, wherein providing the information to the second core network component comprises:
providing a Session Report Request (SRR) information element (IE) that includes QoS monitoring parameters.

13. The method of claim 10, further comprising:
selecting packets, from packets that belong to the flow;
encapsulating each of the selected packets in a General Packet Radio Service Tunneling Protocol-User Plane (GTP-U) PDU session container, with an extension header; and
sending the selected packets in the GTP-U PDU session containers to the access station via a GTP-U tunnel between the second core network component and the access station.

14. The method of claim 13, further comprising:
receiving a selected packet from the second core network component;
generating a reporting packet based on the received selected packet; and
sending the porting packet to the second core network component in a GTP-U PDU session container, along with an extension header associated with the reporting packet.

15. The method of claim 13, further comprising:
receiving, from the access station, a reporting packet that corresponds to the selected packet;
extracting, from an extension header associated with the reporting packet, timestamps; and
determining packet delays per flow based on the extracted timestamps and a time of receipt of the reporting packet.

16. The method of claim 13, wherein the extension header includes indications of either per QoS flow monitoring or per service flow monitoring.

17. The method of claim 16, wherein the indications of per service flow monitoring include spare bits in a first octet of the extension header.

18. The method of claim 10, further comprising:
conducting a Packet Forwarding Control Protocol (PFCP) session with the first core network component, to provide parameters for QoS monitoring per service flow over the PFCP session.

19. A non-transitory computer-readable medium comprising processor-executable instructions, wherein when executed by a processor associated with a first core network component, cause the processor to:
receive, from a second core network component, a reply which indicates that a Quality-of-Service (QoS) monitoring is to be performed for a flow associated with a User Equipment device (UE);
provide information to a third core network component to establish a Protocol Data Unit (PDU) session with the UE and monitor the PDU session over a transport network; and
send a message to a fourth core network component that notifies an access station to allocate resources for the PDU session.

20. The non-transitory computer-readable medium of claim 19, wherein when receiving the reply, the processor is configured to:
receive Policy and Charging Control (PCC) rules, wherein the PCC rules include Qos monitoring parameters.
